(19) United States
(12) Patent Application Publication
(10) Pub. No.: US 2005/0173189 A1
(43) Pub. Date: Aug. 11, 2005

(54) Ladder hazard alert

(76) Inventor: Philip Berardi, Thousand Oaks, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/056,834

(22) Filed: Feb. 10, 2005

Related U.S. Application Data
(60) Provisional application No. 60/543,336, filed on Feb. 10, 2004.

(51) Int. Cl. E06C 7/00

(52) U.S. Cl. 182/18; 182/129

(57) ABSTRACT

There is disclosed a hazard alert system and process. The system may comprise a ladder having a hazardous step, a circuit integrated with the top step, and an alarm connected to the circuit. The circuit may be closed when a predetermined force is applied to the top step. The alarm may be powered when the circuit is closed. The process may comprise an alarm activating when a predetermined force is applied to a hazardous step of a ladder.

### RELATED APPLICATION INFORMATION

This application claims priority from Provisional Application No. 60/543,336, filed Feb. 10, 2004, which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to ladders, platforms, scaffolds and other mechanical elevating devices which exhibit inherent risk of personal injury to a user from common falls from the device.

2. Description of the Related Art

Ladders are common mechanical devices used to elevate a person. It is well documented that more than 30,000 people are injured each year by falls involving ladders. ANSI and OSHA have generated guidelines on proper safety and usage of ladders.

It is well documented that most ladder accidents are caused by human error, not by ladders falling. Common causes of ladder accidents include over-reaching from ladders rather than moving them, standing at the very top of a short ladder rather than using one long enough for the job, and standing on the top step. Safety guidelines for preventing falls from ladders include: not reaching too far forwards or sideways; using both hands when going up or down a ladder; not standing on the top two steps of a stepladder; not overreaching; staying centered on the ladder; not stepping on the top step or platform of a ladder; for every four feet in elevation, there should be one foot of horizontal displacement to ensure a minimum angle of ascent for the ladder. ANSI/OSHA Document Number 132 states that a user of a ladder should “never stand on the top two rungs of a stepladder or top four rungs of an extension ladder.”

There exist a variety of safety devices that have been utilized to improve ladder safety. Such devices include rubber mats to prevent slippage, devices to ensure a level surface for the ladder to sit on, fiberglass materials to reduce conductivity, and drawers to hold tools.

### DESCRIPTION OF THE DRAWINGS

FIG. 1 is perspective view of a hazard alert system.

FIG. 2 is a perspective view of a step.

FIG. 3 is a perspective view of a step.

FIG. 4 is a perspective view of a step.

FIG. 5 is a perspective view of an electronics.

### DETAILED DESCRIPTION OF THE INVENTION

Throughout this description, the embodiments and examples shown should be considered as exemplars, rather than limitations on the apparatus and methods of the present invention.

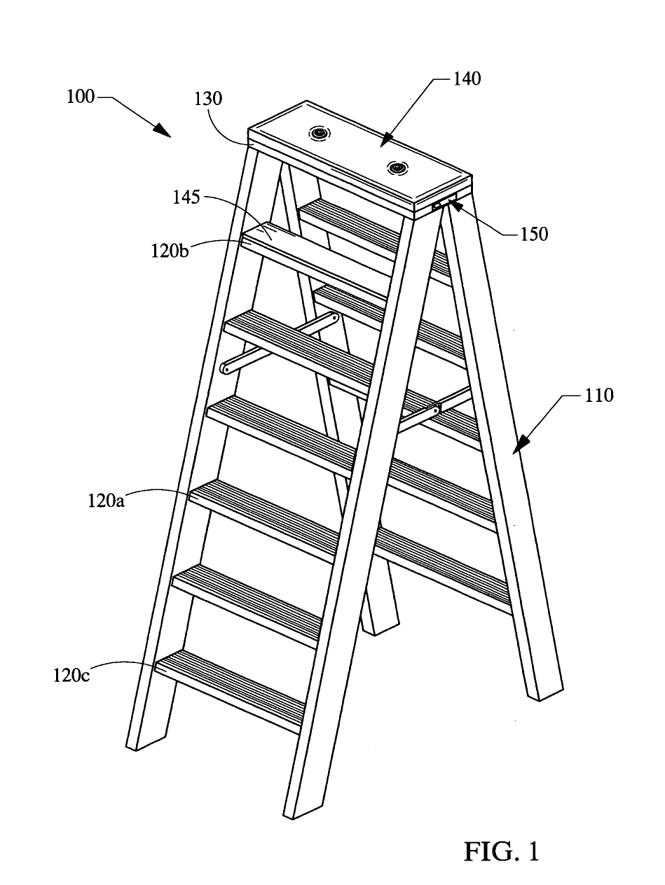

Referring now to FIG. 1, there is shown a hazard alert system 100 comprising a ladder 110, a switch 140, and an alarm 150. The term ladder refers to a structure for use in climbing up or down that typically includes two parallel sidepieces joined at short intervals by a series of steps, rungs, or cleats that serve as rests for the feet. The ladder 110 shown is a standard stepladder. However, the ladder 110 may be a stepladder, a platform ladder, a trestle type ladder, an extension ladder, a straight ladder, a folding ladder, a two sided folding ladder, an A-frame ladder, an A-frame ladder with an extension, or other. The hazard alert system 100 may be used with any ladder type. The hazard alert system 100 may be a portable system or a permanently installed system. The ladder 110 may be constructed of a material such as wood, aluminum, fiberglass, plastic or other.

The ladder 110 may comprise a step 120a or a plurality of steps 120a. The ladder 110 may comprise a top step 130. The top step 130 may be a traditional ladder step, or an extended platform. The ladder 110 may comprise a step 120b immediately below the top step 130. The term immediately below refers to the next step, rung, or cleat that is below a step, rung or cleat in a series of steps, rungs, or cleats. Immediately below may be vertically displaced. Immediately below may be displaced both vertically and horizontally.

The term hazardous step refers to a step of a ladder on which if a person stands, steps, or leans, the person has a high risk of falling from the ladder. The hazardous step of a ladder is typically the top step 130 and/or the step 120b immediately below the top step 130 of the ladder. For a stepladder or a folding ladder, a hazardous step is typically any step, rung or cleat within approximately 14 inches of the top of the ladder. For a trestle type or extension ladder, the hazardous step is typically any step, rung, or cleat within approximately 3 feet from the top of the ladder. For an extension ladder, the hazardous steps may be the top four steps of the extension ladder. The hazardous step does not include a bottom step 120c of the ladder 110. Well documented causes of personal injury include where a user of a ladder falls from a hazardous step. People typically fall from the hazardous step of a ladder because the ladder and/or the person becomes unbalanced when a person leans, steps, or stands on the hazardous step. Some ladders have a maximum load capacity of approximately 250 pounds and will fail if a greater load is applied to the ladder.

Employment related injuries pose both substantial economic risk to employers and personal injury to employees. Moreover, employers are subject to the ever rising costs of workers compensation insurance and law suits for negligence.

Workplace safety is enhanced by humans supervising, inspecting, and observing ladder usage in the workplace. Such persons performing supervisory, inspecting, and observing functions may warn employees and contractors of potential risks when they are violating safety standards. Such potential risks include a user of a ladder stepping or standing on the top step of a ladder or the step immediately below the top step of a ladder. Employers expend substantial costs on safety bulletins, safety training programs and employees attempting to prevent other employees from stepping or standing on the top step 130 or the step 120b immediately below the top step 130 of the ladder 110.

The dimensions of the steps 120a, the step 120b, and the top step 130 may vary with regard to width, length, height, cross sectional dimensions, and material. Moreover, the steps 120a, the step 120b, and the top step 130 may comprise a protective covering such as a compressible rubber mat, plastic material, a grout or other material to reduce conductivity and increase the coefficient of friction.

The top step 130 may comprise a switch 140. The term switch refers to any circuit, mechanical device or electromechanical device which when closed, allows power to flow, and when open, prevents power from flowing. Examples of switches include platform switches, pressure mat switches, ribbon switches, tape switches, adhesive membrane switches, force sensitive switches, and pressure sensitive switches. Switches may be normally open or normally closed. The switch 140 may be attached to the top step 130. The switch 140 may be integrated with the top step 130. The switch may be associated with the top step 130.

The switch 140 may be activated when a predetermined force or pressure is applied to the top step 130. A force or pressure may be applied to the top step 130 when a user of the ladder 110 leans, steps or stands on the top step 130. A force may be applied to the top step 130 when a user of the ladder 110 places tools on the top step 130. The predetermined force or pressure may be selected based on a force or pressure indicative of a user stepping, standing, or leaning on the top step 130. An example of a predetermined force that may activate the switch 140 is 15 pounds or other force.

The step 120b may comprise a switch 145. The switch 145 may be activated when a predetermined force or pressure is applied to the step 120b. The switches 140 and 145 may be electrically and/or mechanically connected.

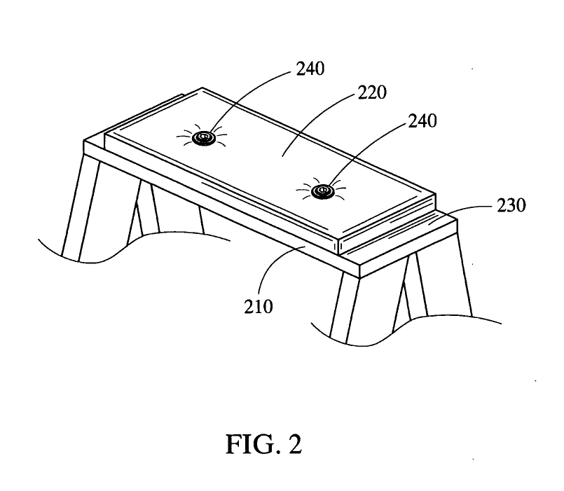

Referring now to FIG. 2, there is shown a hazardous step 210 and a compressible mat 220. A switch (not shown) may be disposed within the compressible mat 220. The switch may be integrated with the compressible mat 220. The switch may be activated when a predetermined force or pressure is applied to the compressible mat 220. The compressible mat 220 may be attached to the upper surface 230 of the hazardous step 210. The compressible mat 220 may be attached to the hazardous step 210 with a mechanical fastener 240. The mechanical fastener 240 may be a screw, rivet, snap in tab, or other. The compressible mat 220 may be attached to the hazardous step 210 with an adhesive. The adhesive may be a cement, glue, chemical bonding agent, or other. The adhesive may be integrated with the hazardous step 210.

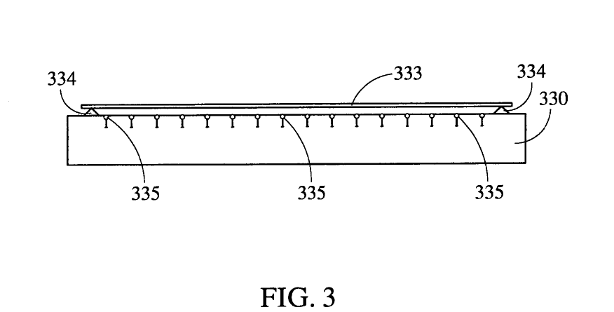

Referring now to FIG. 3, there is shown a switch 340 integrated with a hazardous step 330. The switch 340 may comprise a thin film layer 333. The thin film layer 333 may be constructed of a conductive material. The thin film layer 333 may be disposed directly above the hazardous step 330. The thin film layer 333 may be separated from the hazardous step 330 by at least one ridge 334. When force is exerted on the thin film layer 333, the thin film layer 333 may be displaced to be in contact with the hazardous step 330. The hazardous step 330 may comprise an electrical circuit 335 which remains open while there is no force exerted on the thin film layer 333. When force is applied to the thin film layer 333, the thin film layer 333 may flex and contact the hazardous step 330. When the thin film layer 333 contacts the hazardous step 330, the electrical circuit 335 may close. Additional non-traditional switches may include a linear transducer that measures flexure or horizontal deformation of a step.

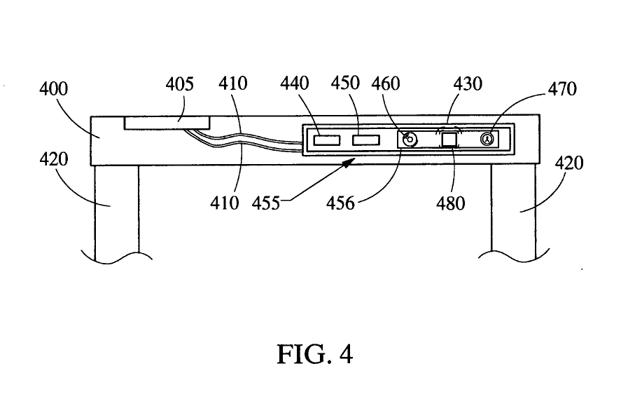

Referring now to FIG. 4, there is shown a hazardous step 400, a switch 405, and an alarm 455. The term alarm refers to a device which provides a notice, warning, or announcement calling attention to a hazardous event or condition. The alarm 455 may be electrically connected to the switch 405 via wires 410 or a circuit. The alarm 455 may be disposed within the hazardous step 400, within a step (not shown) that is not the hazardous step 400, or another portion of the ladder 110. The alarm 455 may be attached to the hazardous step 400 or another portion of the ladder 110.

The alarm 150 may comprise an enclosure 430, a power source 440, an electronics 450, and an alerting device 456.

The enclosure 430 may protect the power source 440, the electronics 450, and the alerting device 456. The enclosure 430 may be constructed of a rigid material which resists impact such as aluminum, fiberglass, plastic, steel, or other. The enclosure 430 may be resistant to environmental conditions such as temperature and moisture. Examples of temperature conditions that the enclosure 430 may need to resist are negative 40 degrees Fahrenheit and 125 degrees Fahrenheit. Examples of moisture conditions that the enclosure may need to resist are condensation and dripping of water.

The term power source refers to a device or system which provides electrical power. Power sources may include one of or combinations of a battery, a solar cell, an industrial building's AC power, and a household AC power. The power source 440 may be selected, configured or adapted based on the alerting device 456 that will be powered. The power source 440 may comprise a battery such as a standard 9V or CR2 battery. The battery may be rechargeable or for one time use. The power source 440 may include a battery charger (not shown). If the alarm 150 comprises complex electronics 450, the power source 440 may comprise a commercial 12V battery coupled to a DC switching device adapted to provide power to the electronics 450. The power source 440 selected for the specific application may be selected for the utility of reducing the frequency of replacing or recharging the battery. There may be two or more batteries, such as one which is permanent and one which is removable. Having a permanent battery may provide protection for periods when the removable battery is removed or depleted.

The term alerting device refers to a device that warns of danger. Examples of alerting devices include horns, sirens, speakers, vibrators, and lights. The term horn refers to a device that makes a warning noise. The term siren refers to a device that makes a warning noise. The term speaker refers to an electro-acoustic device that converts electrical signals into sound. Examples of speakers include coaxial speakers, cone speakers, dynamic speakers, electrodynamic speakers, loudspeakers, and other speakers. The term vibrator refers to a device that vibrates causes vibration or oscillation. The term light refers to a device which produces visible illumination. Lights include arc lamps, fluorescent lamps, incandescent lamps, neon lamps, nernst lamps, light emitting diodes, liquid crystal diodes, and other lights. The alerting device 456 may comprise a speaker 460, a light 470, and a vibrator 480. The speaker 460 may comprise a horn or a siren. The speaker 460 may be a speaker capable of projecting a single frequency or many frequencies. The speaker 460 may be large or small. The speaker 460 may emit a voice or music.

The electronics 450 may be electrically connected to the switch 405, the wires 410, the power source 440, and the alerting device 456. The electronics 450 may provide functionality for voice projection, sirens, sequencing of alerts, lights, vibrating, volume controls, programmability or wireless operation.

Alternatively or in addition, the alarm 455 may be located external to and remote from the ladder. If the alarm 455 is located external to and remote from the ladder, the alarm 455 may receive radio signals from a transmitter (not shown) associated with the switch 405. Alternatively, the alarm 455 may receive an infrared signal from a transmitter (not shown) associated with the switch 405. A signal to activate the alerting device 456 may be sent electronically to an external device such as a computer on a computer network, a cell phone, a pager, a personal data assistant, a personal communication device, or other.

The switch 405, the power source 440, and the alerting device 456 may be electrically connected in a circuit. If a predetermined force or pressure is applied to the switch 405, the switch 405 may be activated. The predetermined force or pressure may be selected based on a person stepping, standing, or leaning on a step of a ladder. An example of a predetermined force may be 15 pounds or other force. If the switch 405 is activated, power may flow from the power source 440 to the alerting device 456. If the alerting device 456 receives power, the alerting device may alert a user of impending danger.

The alert associated with the switch 405 being activated may comprise periodically, either concurrently or in sequence, at least one of a vibration, an illumination of a light, a voice projection of pre-recorded message and a siren to indicate danger. The pre-recorded message may generate a voice alert, “danger, no stepping, standing, or leaning on the ladder's top step or hazardous step immediately below the top step.” The alert may cycle with increasing volume at varying audible frequencies and timing frequencies. The alert may be used as a signal for a danger prevention employee or the employer to promptly address the potential hazard. The alert may be utilized to alert the user that the user is utilizing the ladder (not shown) in an unsafe manner.

If a person leans, steps or stands on the hazardous step of the ladder and then observes the alert, it is likely that the person will cease leaning, stepping, or standing on the hazardous step of the ladder. By reducing the frequency of persons leaning, stepping or standing on the hazardous steps of ladders, less people will fall from ladders. If less people fall from ladders, less personal injury will occur. If less personal injury occurs, companies may reduce the number of supervising, inspecting, and observing duties for ladder safety. Reducing the amount of injuries may help companies reduce insurance costs, medical costs, and legal costs.

Alternatively to a switch 405, a hazard alert system may utilize a sensor (not shown). The term sensor refers to a device that responds to a physical stimulus, such as a force, pressure, motion, interruption, or change in magnetic field, and transmits a resulting signal for interpretation or measurement or for operating a control. The term signal refers to an electric quantity which represents information about the source from which it originates. Examples of sensors include force sensors, pressure sensors, flexure sensors, motion sensors, proximity sensors, infrared sensors, photo-sensors, lasers and other sensors. The sensor may be integrated with, associated with, or attached to the hazardous step 400 or the ladder 420. The sensor may be electrically connected to the electronics 450.

If a person leans, steps, or stands on the hazardous step 400, the sensor may transmit a signal to the electronics 450. If the electronics 450 receives a signal from the sensor, the electronics 450 may cause power to flow from the power source 440 to the alerting device 456. By causing power to flow to the alerting device 456, the electronics may cause an alert. The alert may include a horn sounding, a siren sounding, a speaker sounding, a vibrator vibrating, light emitting or combinations therein.

If the electronics 450 receives a signal from the sensor, the electronics 450 may cause an e-mail, an SMS message, a pager message, and/or a voice message to be sent to a supervisor or other safety person notifying the person that a person is using a ladder in an unsafe fashion. If the electronics 450 receives a signal from the sensor, the electronics 450 may cause a record to be recorded in a table or a database. The term database refers to a collection of data, information of records organized especially for rapid search and retrieval by a device such as a computer. A database might be a single electronic file including many records. The term record refers to information stored in electronic, magnetic or optical form that is reproducible by a device such as a computer. The record may include an identifier or information associated with a specific ladder, the time of day, which switch or signal was activated, how long the switch or signal was activated for, how long a duration that an alert was provided, and other information. The record may be stored via a hard disk, a network storage device, a non-volatile memory, or other electronic storage medium.

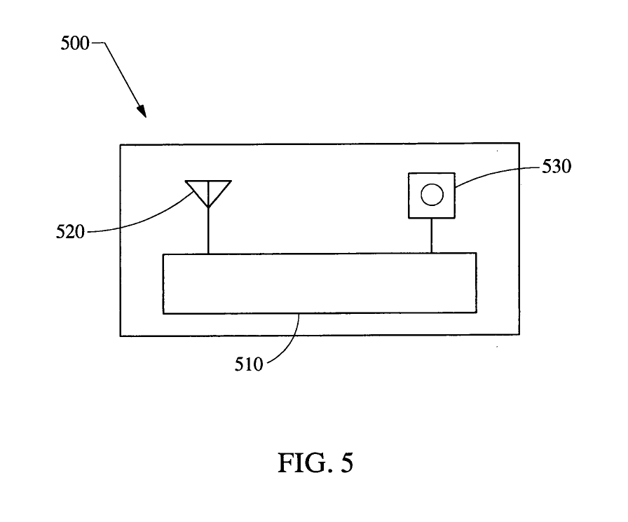

Referring now to FIG. 5, there is shown an electronics 500. The term electronics includes, but is not limited to, personal computers, server computers, computing tablets, computer workstations, set top boxes, telephones, personal digital assistants (PDAs), portable computers, and laptop computers. These computing devices may run an operating system, including, for example, the Microsoft Windows, Linux, Unix, MS-DOS, Palm OS, and the Apple Mac OS X operating systems. The operating system may include network communications software that allows for communication over a network. The network communications software may provide support for communications according to protocols such as UDP, TCP, IP and others. The network communications software may provide support for wired and/or wireless network communications.

The electronics 500 may comprise a circuit 510, a radio receiver 520, and an infrared receiver 530. The radio receiver 520 may be electrically connected to the circuit 510. The radio receiver 520 may receive radio signals from a switch (not shown), a transmitter (not shown) associated with the switch, or other. The infrared receiver 530 may be electrically connected to the circuit 510. The infrared receiver 530 may receive infrared signals from the switch, a transmitter associated with the switch, or other. The circuit 510 may comprise logic instructions to control either concurrently or in a programmed sequence, at least one of an audible alert, a voice message, a light, and a vibration.

The circuit 510 may monitor battery capacity. If battery capacity reduces below a predetermined minimum level, the circuit 510 may cause the alerting device (not shown) to emit an alert. A predetermined minimum level may be 15% or 20% of the battery capacity. The alert associated with low battery capacity may be similar to a signal of a fire alarm which indicates the battery of the fire alarm is below minimum capacity. The alert associated with low battery capacity may comprise a voice generation of the words “low battery.” The alert associated with low battery capacity may comprise illuminating an LED. The alert associated with low battery capacity may comprise periodically, either concurrently or in sequence, at least one of a vibration, an illumination of an LED, a voice generation of a pre-recorded message, and a chirp. The circuit 510, when the battery capacity falls below a predetermined minimum level may send a message, for example via SMS or e-mail, to an external device such as a computer on a computer network. A user on the computer may be another employee or the employer who monitors ladder usage.

The hazard alert system 100 may comprise a sensor (not shown) to monitor if the ladder 110 is level. The sensor may provide a signal to the circuit 510 if the ladder is not level. If the circuit 510 receives a signal from the sensor, the circuit 510 may cause an alert. The alert associated with the sensor may cause periodically, either concurrently or in sequence, at least one of a vibration, an illumination of an LED, a voice projection of pre-recorded message and a siren to indicate danger. The pre-recorded message may project “danger, ladder not level.” The alert may cycle with increasing volume at varying audible frequencies and timing frequencies. The alert may be used as a signal for a danger prevention employee or the employer to promptly address the potential hazard. The alert may be utilized to alert the user that the user is utilizing the ladder in an unsafe manner. The circuit 510 may send a text message via SMS or e-mail to a user on a computer network to indicate that the ladder is not level.

The circuit 510 may comprise a logic circuit and/or software which monitors power consumption. The circuit 510 may draw a reduced amount of power from the battery at times when the switch is not activated and the battery is not below the minimum capacity.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

1. A ladder comprising:
a bottom step
a top step
a step immediately below the top step
a first pressure sensitive switch attached to the top step, wherein the first pressure sensitive switch is selected from the group comprising a platform switch, a pressure mat switch, a ribbon switch, a tape switch, and an adhesive membrane switch
a second pressure sensitive switch attached to the step immediately below the top step, wherein the second pressure sensitive switch is selected from the group comprising a platform switch, a pressure mat switch, a ribbon switch, a tape switch, and an adhesive membrane switch
an alarm comprising
a circuit connected to the first pressure sensitive switch and the second pressure sensitive switch
a power source connected to the circuit
an alerting device connected to the circuit, wherein the alerting device is selected from the group comprising a horn, a siren, a speaker, a vibrator, and a light.

2. A hazard alert system comprising:
a ladder having a hazardous step
a circuit integrated with the hazardous step, wherein the circuit is closed when a predetermined force is applied to the hazardous step
an alarm connected to the circuit, wherein the alarm is powered when the circuit is closed.

3. The ladder of claim 2 wherein the hazardous step is selected from the group comprising a top step and a step immediately below the top step.

4. The ladder of claim 3 wherein the hazardous step is not a bottom step.

5. The ladder of claim 2 wherein the alarm comprises an alerting device selected from the group comprising a horn, a siren, a speaker, a vibrator, and a light.

6. A ladder comprising:
a hazardous step
a sensor integrated with the hazardous step
a circuit connected to the sensor, wherein the circuit is adapted to receive a signal from the sensor when a predetermined force is applied to the hazardous step
an alarm connected to the circuit, wherein the alarm is adapted to activate in response to the circuit receiving the signal.

7. The ladder of claim 6 wherein the hazardous step is selected from the group comprising a top step and a step immediately below the top step.

8. The ladder of claim 7 wherein the hazardous step is not a bottom step.

9. The ladder of claim 6 wherein the sensor is selected from the group comprising a force sensor, a pressure sensor, a motion sensor, an infrared sensor, a proximity sensor, a photo-sensor.

10. The ladder of claim 6 wherein the alarm includes an alerting device selected from the group comprising a horn, a siren, a speaker, a vibrator, and a light.

11. A hazard alert process comprising:
an alarm activating when a predetermined force is applied to a hazardous step of a ladder.

12. The hazard alert process of claim 11 wherein the hazardous step is selected from the group comprising a top step and a step immediately below the top step.

13. The hazard alert process of claim 12 wherein the hazardous step is not a bottom step.

14. The hazard alert process of claim 11 wherein the predetermined force is 15 pounds.

15. The hazard alert process of claim 11 further comprising a sensor sending a signal to a circuit when the predetermined force is applied to the hazardous step.

16. The hazard alert process of claim 15 wherein the sensor is selected from the group comprising a force sensor, a pressure sensor, a motion sensor, an infrared sensor, a proximity sensor, a photo-sensor.

17. The hazard alert process of claim 15 further comprising the circuit causing an electronic notification to be sent to a user when the circuit receives the signal.

18. The hazard alert process of claim 17 wherein the electronic notification is selected from the group comprising an e-mail, an SMS message, a pager message, and a voice message.

19. The hazard alert process of claim 15 further comprising the circuit causing a record to be recorded in a database in response to the signal.

20. The hazard alert process of claim 19, wherein the record includes an information associated with the ladder and when the signal was received.

21. The hazard alert process of claim 11 wherein the alarm activating comprises an alert selected from the group comprising a horn sounding, a siren sounding, a speaker sounding, a vibrator vibrating, and a light emitting.

22. A hazard alert process comprising:
a sensor transmitting a signal to a circuit in response to a person stepping on a hazardous step of a ladder
the circuit causing an alert in response to the signal.

23. The hazard alert process of claim 22 wherein the hazardous step is selected from the group comprising a top step and a step immediately below the top step.

24. The hazard alert process of claim 23 wherein the hazardous step is not a bottom step.

25. The hazard alert process of claim 22 wherein the sensor is selected from the group comprising a force sensor, a pressure sensor, a motion sensor, an infrared sensor, a proximity sensor, a photo-sensor.

26. The hazard alert process of claim 22 wherein the alert is selected from the group comprising a horn sounding, a siren sounding, a speaker sounding, a vibrator vibrating, and a light emitting.

27. The hazard alert process of claim 22 further comprising the circuit causing an electronic notification to be sent to a user when the circuit receives the signal.

28. The hazard alert process of claim 27 wherein the electronic notification is selected from the group comprising an e-mail, an SMS message, a pager message, and a voice message.

29. The hazard alert process of claim 22 further comprising the circuit causing a record to be recorded in a database in response to the signal.

30. The hazard alert process of claim 29 wherein the record includes an identifier associated with the ladder and when the signal was received.

31. A ladder comprising:
a hazardous step
a switch associated with the hazardous step
an alarm connected to the switch.
